(19) United States
(12) Patent Application Publication
(10) Pub. No.: US 2010/0066539 A1
(43) Pub. Date: Mar. 18, 2010

(54) SURVEILLANCE DEVICE

(75) Inventor: Ulrich Zinner, Philadelphia (ZA)

Correspondence Address: CONNOLLY BOVE LODGE & HUTZ LLP, 1875 EYE STREET, N.W., SUITE 1100, WASHINGTON, DC, 20006, US

(73) Assignee: BELL-OAK INVESTMENT (PROPRIETARY) LIMITED, PHILADELPHIA (ZA)

(21) Appl. No.: 12/525,430

(22) PCT Filed: Jan. 31, 2008
(86) PCT No.: PCT/IB2008/050364

§ 371 Date: Nov. 2, 2009

(30) Foreign Application Priority Data
Jan. 31, 2007 (ZA) 2007/00889

(51) Int. Cl. G08B 13/14

(52) U.S. Cl. 340/572.9

(57) ABSTRACT

An EAS tag (10) is provided which includes a lock mechanism (36) inside its body (15) for holding a shank (26) of a tack (12) captive and releasing the shank (26). The lock mechanism (36) includes a resilient detent (38) which includes a fixed part (52) that is fixedly mounted in the body (15) and a resiliently displaceable part (54) which is movable relative to the body (15) and which and which is accessible with a probe (14) from outside the body (15). An aperture (40) in which the shank (26) is receivable is defined in the detent (38) adjacent each of the fixed part (42) and the displaceable part (54). To release the lock mechanism (36), a probe (14) is passed into the tag body (15) to press the displaceable part (54) and move it relative to the fixed part (52), thus deforming the detent (38) resiliently such that the aperture (40) is also deformed to release the shank (26).

### FIELD OF THE INVENTION

This invention relates to electronic article surveillance (EAS) security devices or security tags that can be applied to articles such as merchandise to inhibit theft or pilfering. In particular, the invention relates to an EAS tag with an improved locking mechanism and a method of using the EAS tag.

### BACKGROUND TO THE INVENTION

Security devices in the form of tags that can be attached to merchandise in EAS systems are widely used to alert retailers to unauthorised removal of tagged merchandise from their premises. One such EAS device is known as a “hard tag” and includes a rigid body housing an EAS marker (also known in the art as a “sensor”) and a tack. The tack has a shank with a sharp end that can pass through an article of merchandise and that can be received in an aperture in the tag body, where it is held firmly to prevent removal of the tag from the article of merchandise. When the merchandise may legitimately leave the premises under surveillance, the tag is removed from the article of merchandise with a purpose built detacher, which releases the tack to be withdrawn from the body. The EAS tag can be configured as a disposable or re-usable tag.

One mechanism for the attachment and removal of a re-usable hard tag that is commonly used is described in U.S. Pat. No. 5,426,419 (the Nguyen Patent) and includes a lock mechanism in one part of the body and an elongate cavity defined in another part of the body, in which the sensor can be housed. The lock mechanism includes a detent (clamp plate) with an aperture in which the shank of the tack is receivable in a clipping manner to be held captive until the detent is pivoted to release the tack shank. In order to pivot the detent, the tag is placed in a tag detacher device, in which part of the tag body fits snugly and a curved probe is inserted into the tag body, to pivot the detent. The description of the Nguyen Patent is included herein in its entirety, by reference.

The tag described in the Nguyen Patent has been found to be large and cumbersome and in more recent versions of this tag, the elongate part of the body that houses the sensor has been made shorter. However, a need has developed to house more than one type of sensor in each tag, thus allowing each tag to be used in a variety of surveillance systems. The tag could for instance include any one or more sensors selected from radio frequency (RF) sensors, acousto-magnetic (AM) sensors, electromagnetic (EM) sensors, or the like.

There is thus simultaneously a need for tags to be compact and to have sufficient space available to house multiple sensors. The pivotal movement of the detent in the lock mechanism disclosed in the Nguyen Patent requires space inside the tag body and thus prevents the body from being made significantly smaller, especially if it needs to house multiple sensors.

The large scale use of tags with the configuration described in the Nguyen Patent has had the result that many retailers already have tag detacher devices that are configured to receive the part of this particular configuration of tag body in which the lock mechanism is housed and to penetrate the tag body with the suitably configured probe. Accordingly, it would be preferable if the shapes of new tag bodies are such that they are compatible with these existing tag detachers.

The present invention seeks to provide an EAS tag that is compact and that can be used in combination with conventional tag detacher devices. The invention further seeks to provide sufficient space inside the EAS tag body to house multiple sensors, preferably different types of sensors.

### SUMMARY OF THE INVENTION

According to one aspect of the present invention there is provided an EAS tag which includes a body in which a lock mechanism is housed for receiving a shank of a tack, for holding the shank captive and for releasing the shank when the lock mechanism is released, said lock mechanism including a resilient detent which defines an aperture in which the shank is receivable in a locking manner, wherein the detent includes a fixed part that is fixedly mounted in the body and a resiliently displaceable part which is movable relative to the body and which is accessible with a probe from outside the body, the aperture being defined adjacent each of the fixed part and the displaceable part, the detent being configured to be deformed resiliently if its displaceable part is moved relative to its fixed part and the aperture being configured to release the shank, when the detent is so deformed.

The aperture in the detent may be defined generally between the fixed part of the detent and the displaceable part of the detent.

The aperture may be defined by recesses in the fixed part and the displaceable part, respectively and a large recess may be defined adjacent the recess in at least one of these parts, which large recess may be brought into register with one of the recesses when the detent is resiliently deformed.

The detent may be a unitary component of a resilient material, e.g. it may be of an elastic material and may include at least one resiliently deformable or spring element extending between its fixed part and its resiliently displaceable part.

According to another aspect of the present invention there is provided a method of using an EAS tag, said method including:

receiving a shank of a tack in an aperture defined in a detent, to hold the shank captive in the aperture; and

releasing the shank from the detent by exerting a load from a probe onto the detent and causing part of the detent to be resiliently deformed, the deformation causing the shape of the aperture to be deformed sufficiently for the shank to be released from the detent.

The deformation of the detent and its aperture may be reversed by the resilience of the detent, when the load from the probe is released.

Part of the detent may be fixedly mounted on an inside of a body of the tag and the method may include passing the probe into the tag body from its outside. The probe may have a curved shape and may move arcuately inside the tag body. The probe may be pressed directly or indirectly against the detent at a point remote from the fixed attachment of the detent.

According to a further aspect of the present invention there is provided an EAS tag which includes a body in which a lock mechanism is housed for receiving a shank of a tack, for holding the shank captive and for releasing the shank when the lock mechanism is released, wherein said lock mechanism includes a resilient detent that is slidably mounted in the body and at least part of which is accessible with a probe from outside the body, said detent defining an elongate slot in which the shank of the tack is receivable in a locking manner and said detent being configured to slide when receiving a load from said probe, said sliding causing the tack shank to be released from the slot.

The slot in the detent may extend generally in the direction of sliding movement of the detent.

The detent may define one or more resilient gripping formations on the periphery of the slot, which can grip the tack shank, when received inside the slot.

The tag may include biasing means, such as a spring, configured to urge the detent against the direction in which it can be urged by the probe.

According to yet a further aspect of the present invention there is provided a method of using an EAS tag which method includes:

receiving a shank of a tack in a slot defined in a detent to hold the shank captive; and

releasing the shank from the detent by exerting a load from a probe onto the detent and causing the detent to slide, the sliding movement causing the tack shank to be released be released from the slot.

The sliding movement of the detent may be reversed by a biasing load exerted on the detent, when the load from the probe is released.

The detent may be fixedly mounted on an inside of a body of the tag and the method may include passing the probe into the tag body from its outside. The probe may have a curved shape and may move arcuately inside the tag body.

### BRIEF DESCRIPTION OF THE DRAWINGS

For a better understanding of the present invention and to show how the same may be carried into effect, the invention will now be described by way of non-limiting example, with reference to the accompanying drawings, in which:

FIG. 1 shows a three dimensional view of an EAS tag and its associated tack, in accordance with a first embodiment of the present invention, with the tack withdrawn;

FIG. 2 shows a sectional side view of the tag and the tack of FIG. 1, with the tack inserted;

FIG. 3 shows a probe and part of the tag of FIG. 1, with the top housing of the body removed, with some internal detail of the tag body omitted and with the detent in its normal condition;

FIG. 4 shows the probe and part of the tag of FIG. 3, with the probe inserted into the tag body and with the detent in a released condition;

FIGS. 5A and 5B show top plan views of the detent of the tag of FIGS. 1 to 4 in its normal and released conditions, respectively;

FIG. 6 shows an exploded view of an EAS tag and its associated tack, in accordance with a second embodiment of the present invention;

FIG. 7 shows an exploded view of an EAS tag and its associated tack, in accordance with a third embodiment of the present invention; and

FIG. 8 shows a part sectional three dimensional view of an EAS tag and its associated tack, in accordance with a fourth embodiment of the present invention.

### DETAILED DESCRIPTION OF THE DRAWINGS

Referring to the drawings, a security device in the form of an EAS tag in accordance with the present invention is generally indicated by reference numeral 10. A tack for use with the tag 10 is generally indicated by reference numeral 12 and a probe for releasing the lock mechanism of the tag 10 is generally indicated by reference numeral 14. Similar reference numerals in different embodiments of the invention are indicated by the same reference numerals.

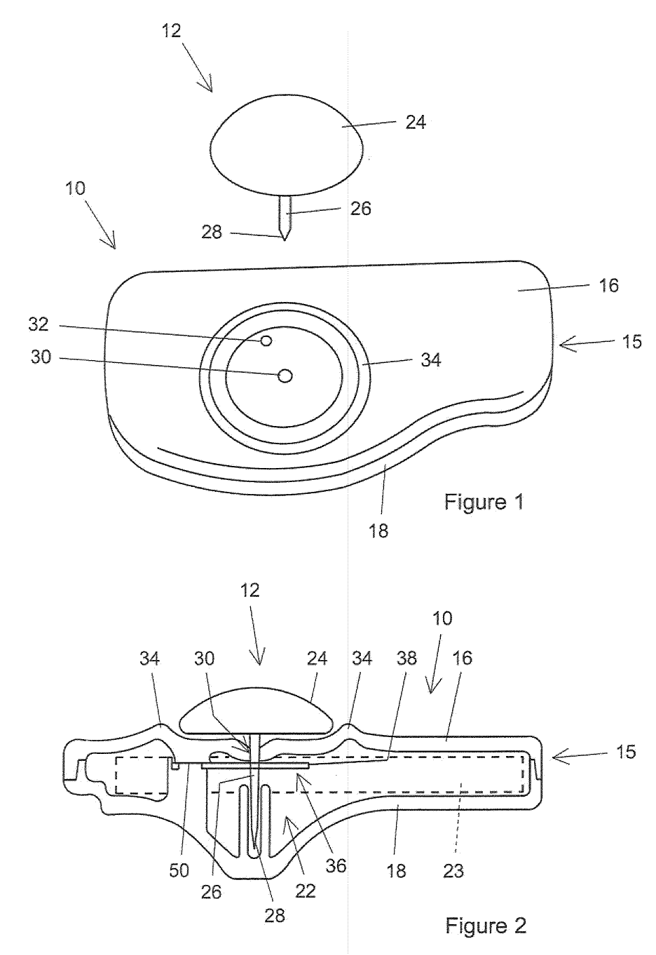

Referring firstly to FIGS. 1 to 5, the illustrated tag 10 in accordance with the first embodiment of the present invention is in the form of a re-usable hard tag, but other types of EAS security devices could also make use of the features of the present invention.

The tag 10 has a body 15 comprising of an upper housing 16 and a lower housing 18. The outer walls of the lower housing 18 has a shape that corresponds in part to the shapes of conventional EAS tags (as described in the Nguyen Patent) and that allows the relevant part of the lower housing to be inserted in a conventional tag detacher and for the probe 14 to be inserted into the tag body 15 via an opening 20, as described in the Nguyen Patent. The upper and lower housings 16,18 define an internal cavity 22 which can include a wide variety of internal walls, spigots, channels, or like features, to house a wide variety of differently shaped components. However, only the components that are relevant for the present invention are described in this specification.

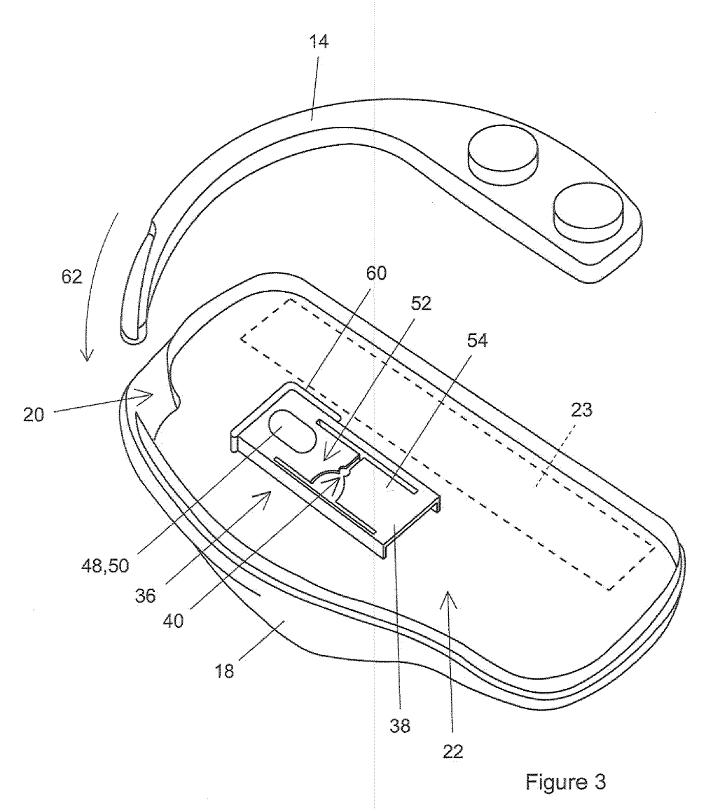

Inside the cavity 22, there is space for one, or preferably more than one EAS marker or sensor 23 to be housed. In a preferred embodiment of the invention, there is more than one type of sensor 23 in the cavity and the sensors can include any one of more of radio frequency (RF) sensors, acousto-magnetic (AM) sensors, electromagnetic (EM) sensors, or the like. Given that the number and type of the sensors 23 can vary greatly, instead of illustrating examples of sensors, the sensors are collectively represented in the FIGS. 2, 3 and 4 by rectangles in broken lines.

The tack 12 includes a large head 24 from which a cylindrical tack body or shank 26 extends to a sharp point 28. The shank 24 can define circumferential ribs, but this is not essential. The shank 26 can be passed through apertures in articles of merchandise or through the merchandise itself and can be inserted into the tag body 15, where it needs to be held captive to attach the tag 10 to the article of merchandise.

Referring to FIGS. 1 and 2, the upper housing 16 defines an opening 30 into which the shank 26 is inserted when the tag 10 is attached to an article of merchandise. When the tag 10 is not in use, the tack 12 is stored by inserting its shank into a storage opening 32, in which the shank is held by a light interference fit, to allow it to be withdrawn easily when needed. The insertion of the shank 26 into the storage opening 32 is intended to prevent injury caused by pricks from the tack point 28 and to prevent the tack 12 and tag 10 from becoming separated.

A circumferential ridge 34 extends at a generally constant radius around the opening 30. When the tack shank 26 is inserted into the opening 30, the tack head 24 is slightly recessed inside the ridge 34, with part of the article to which the tag 10 is being attached, extending between the upper housing 16 and the tack head 24. If attempts are made to pry the tack 12 form the tag 10 by inserting an object between the body 15 and the tack head 24, the ridge 34 not only makes this very difficult, but increases the chances that the article will be damaged and that a would-be thief will be discouraged from attempting this.

Referring to FIGS. 2 to 4, the tag 10 includes means, in the form of a lock mechanism 36 discussed in greater detail below, for releaseably preventing the shank 26 from being withdrawn from the tag body 15. The lock mechanism 36 is configured to be released when the probe 14 is inserted into the body 15 through the opening 20. The probe 14 has a curved shape and moves arcuately, in the conventional manner as described in the Nguyen patent.

The lock mechanism 36 includes a detent 38 that is located inside the body 15 between the upper and lower housings 16,18. The detent has the general shape of a rectangular plate and defines an aperture 40 generally in its centre, through which the shank 26 can pass to be held captive and from which it can selectively be released. The detent can be made from steel or any other suitably durable and resiliently deformable (preferably elastically deformable) material.

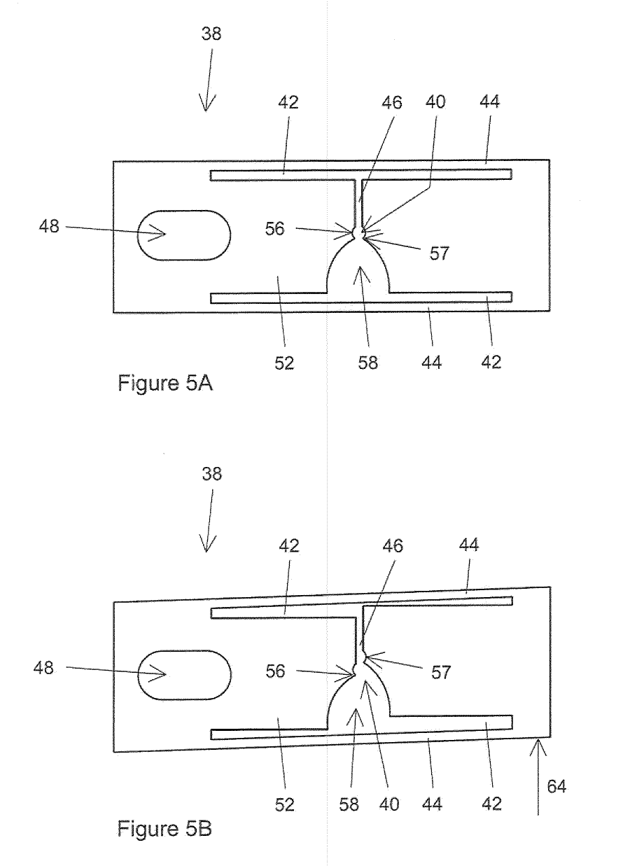

Referring to FIG. 5A, the detent is profiled to define two lateral slots 42, adjacent its lateral edges and the thin elongate part on the outside of each lateral slot forms a spring element 44. A further slot 46 extends perpendicularly between the lateral slots 46 through the aperture 40. The detent 38 defines an oval locating aperture 48 near its one end through which it is fixedly mounted in the body 15 when the housings 16,18 are attached together, with a raised protuberance 50 that extends into the aperture 48 from the lower housing 18. In the illustrated first embodiment, the lateral edges of the detent 38 have been angled downwardly, giving each of the spring elements 44 a deeper profile. It is not essential that the edges of the detent are so angled, but it adds to the stiffness of the spring elements against unwanted bending in a vertical direction and allows bending in lateral directions, as is required in its operation described below.

The part of the detent between the lateral slots 42 and on the same side of the aperture 40 as the aperture 48, forms a fixed part 52 of the detent and is generally prevented by its mounting in the body 15, from moving relative to the body. The part of the detent 38 between the lateral slots 42 and on the side of the aperture 40 that is remote from the fixed part 52, forms a resiliently displaceable part 54 that can move relative to the body 15 to the extent allowed by the resilience of the spring elements 44.

The aperture 40 has a cylindrical outline with a diameter that allows the shank 26 to fit in the aperture with a tight interference fit. However, given that the perpendicular slot 46 passes through the aperture 40, its cylindrical circumference is formed by a part cylindrical recess 56 defined in the fixed part 52 and an identical part cylindrical recess 57 defined in the displaceable part 54. Immediately adjacent the aperture 40, the perpendicular slot 46 widens towards one of the lateral slots 42 to define a large recess or mouth 58 adjacent the aperture 40 that is much wider than the aperture.

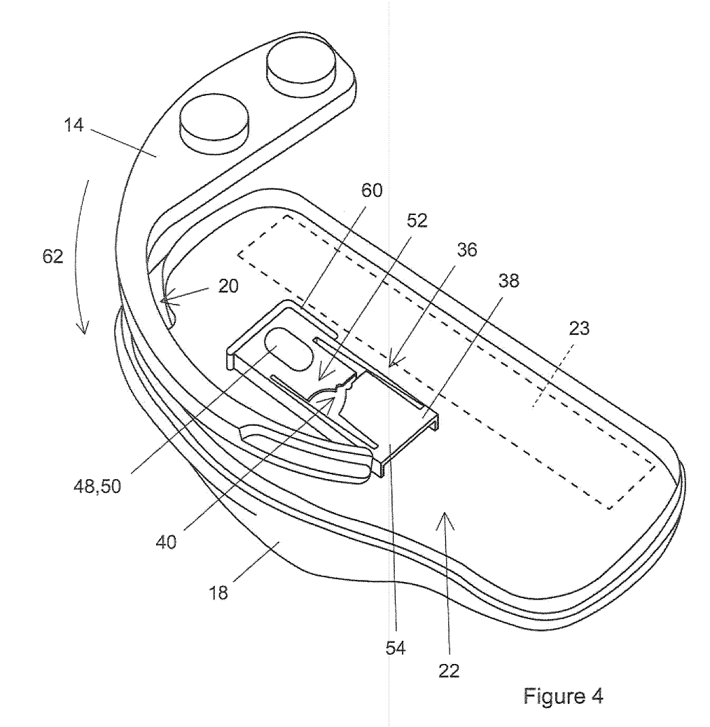

Referring to FIGS. 3 and 4, the detent 38 is mounted in the lower housing 18 with the protuberance 50 extending into the locating aperture 48 and is also located in position by an L-shaped wall 60 extending on two sides adjacent the fixed part 52. These formations, together with the underside of the upper housing 16 locate the fixed part 52 in position. The detent 38 is oriented such that the mouth 58 faces towards a side of the detent that is accessible via the opening 20.

In use, the detent 38 is in its normal condition, as illustrated in FIGS. 3 and 5A. When the tag 10 is to be attached to an article of merchandise, the tack shank 26 is inserted through the opening 30 and part of the shank passes through the aperture 40 until the tack 12 has been fully inserted and the shank is held captive between the recesses 56 and 57. The tapering point 28 of the shank 26 assists in its insertion into the aperture 40 and the generally flat shape of each of the fixed part 52 and displaceable part 54 allows them to flex slightly downwardly while the shank passes between the recesses 56 and 57, until it is held captive.

When the tag 10 needs to be removed from the article of merchandise, the tag is placed in a conventional detacher (not shown), which includes the probe 14. The probe 14 is shown in FIG. 3 in its rest position that it occupies when the tag 10 is placed in position in the detacher.

To release the lock mechanism 36, the probe 14 is moved arcuately in the direction 62 and enters the body 15 via the opening 20. As can be seen in FIG. 4, the probe 14 continues in the direction 62 until it abuts the displaceable part 54 of the detent (preferably directly—as shown in FIG. 4). The abutment of the end of the probe 14 on the displaceable part 54 causes a resultant load on the displaceable part that includes a transverse component, in a direction shown in FIG. 5B by reference numeral 64.

As can be seen in FIGS. 4 and 5B, the transverse load from the probe 14 causes the displaceable part 54 to be displaced in the direction 64, relative to the body and thus causes the detent 38 to be deformed to its release condition. This displacement takes place against the resilience of the spring elements 44 and can be reversed. At the same time, the fixed part 52 remains fixed relative to the body, so that there is a displacement of the recess 57 relative to the recess 56 and the shape of the aperture 40 is also deformed. In particular, the recess 56 in the fixed part 52 comes into register with the mouth 58, so that the aperture 40 is formed by the peripheries of the recess 56 and the mouth 58 and the recess is thus substantially larger than it was before.

The shank 26 remains seated in the recess 56 at all times during this action, but when it is no longer clamped by the tight interference fit between the recesses 56 and 57, upon the increase in size of the aperture 40, the shank is released from the locking mechanism and can be with withdrawn from the tag 10.

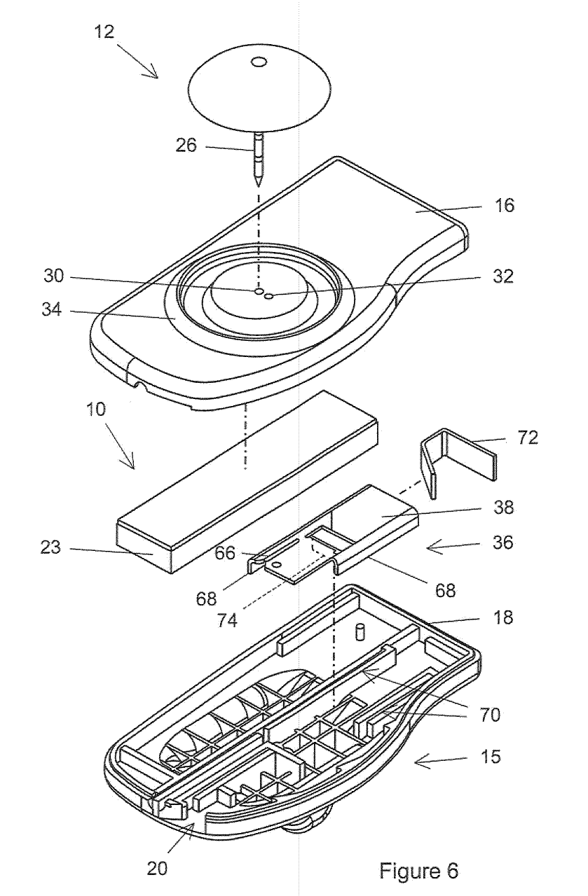

Referring now to FIG. 6, the EAS tag 10 in accordance with the second embodiment of the present invention also includes a body comprising upper and lower halves 16,18 and which is configured to be received in a conventional detacher and to receive a conventional probe through an opening 20. The main difference between this tag and the one shown in FIGS. 1 to 5, is that this tag's lock mechanism 36 includes a slidable detent 38, housed inside the tag body 15.

The slidable detent 38 defines a longitudinal, elongate slot 66 that extends from its end facing the opening 20, in which the shank 26 of the tack 12 is receivable. The detent 38 also has lateral ridges 68 that are slidably receivable in grooves so that the detent can slide in a longitudinal direction and includes a downwardly extending tab 74 (shown in broken lines). The detent is biased towards the opening 20 by a spring 72.

In use, the shank 26 is passed through the opening 30 in the same way as in the first embodiment of the invention, but is received in the slot 66, where it is held captive by resilience of the detent 38, interaction of the edges of the slot with ribs on the shank, or the like. When the tack 12 is to be removed from the tag 10, the probe 14 enters the tag body via the opening 20 in the conventional, arcuate manner and the end of the probe abuts the tab 74 and presses the detent 38 to slide longitudinally against the bias of the spring 72. The sliding movement of the detent 38 causes the slot 66 to move relative to the shank 26 until the shank is no longer held captive in the slot and the shank can be withdrawn from the tag 10. When the probe 14 is withdrawn, the bias of the spring 72 causes the detent to slide longitudinally to its original position, so that the tag 10 can be re-used.

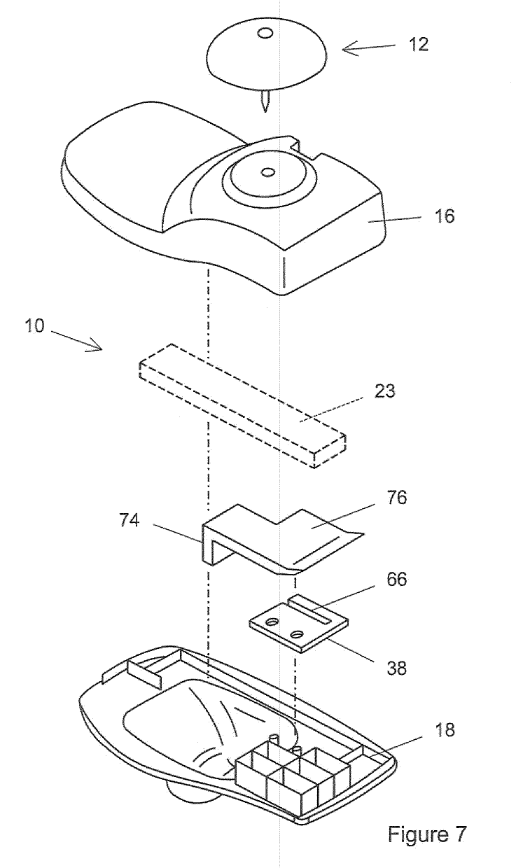

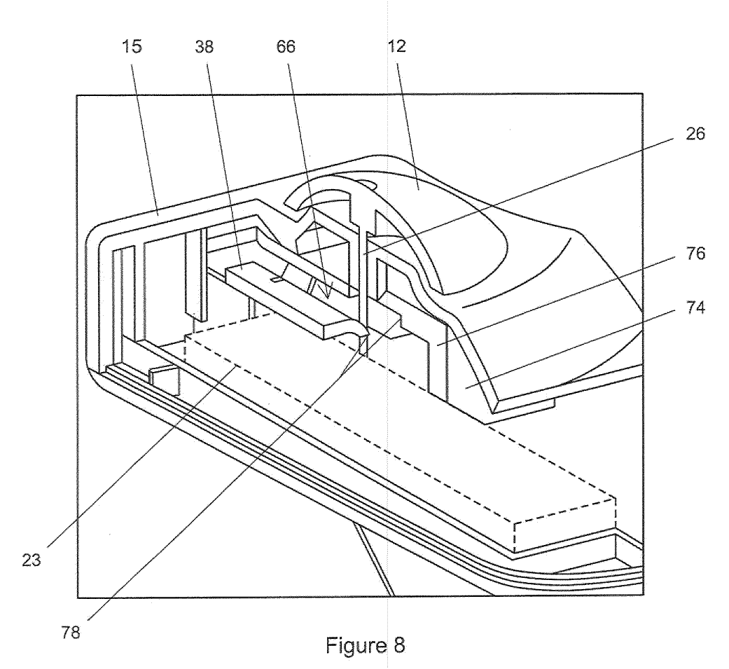

Referring to FIGS. 7 and 8, the tags 10 in accordance with the third and fourth embodiments of the present invention, are non-reusable or disposable and each such tag includes a slidable detent 38, functionally similar to that shown in FIG. 6, but without biasing means that can return the detent to its original position.

The tag 10 shown in FIG. 7 includes a detent 38 in the form of a plate defining the slot 66, which is attached to the underside of a sliding element 76, defining the tab 74.

The tag 10 shown in FIG. 8 functions in much the same way as that shown in FIG. 7, but the inwardly facing edges of the slot 66 are angled downwardly to form retaining formations in the form of biting ridges 78. When the shank 26 enters the slot 66 from above, the angled orientation of the slot's edges causes them to flex outwardly, allowing the shank 26 to enter the slot. Once the shank 26 is inside the slot 66, the ridges 78 are urged by the resilience of the detent 38 to bite onto the shank 26 and thus to hold it captive until the detent is slid longitudinally by the probe 14 as described above.

1. An EAS tag which includes a body in which a lock mechanism is housed for receiving a shank of a tack, for holding the shank captive and for releasing the shank when the lock mechanism is released, said lock mechanism including a resilient detent which defines an aperture in which the shank is receivable in a locking manner, characterised in that said detent includes a fixed part that is fixedly mounted in the body and a resiliently displaceable part which is movable relative to the body and which is accessible with a probe from outside the body, said aperture being defined adjacent each of the fixed part and the displaceable part, said detent being configured to be deformed resiliently if its displaceable part is moved relative to its fixed part and said aperture being configured to release the shank, when the detent is so deformed.

2. An EAS tag as claimed in claim 1, characterised in that the aperture in the detent is defined generally between the fixed part of the detent and the displaceable part of the detent.

3. An EAS tag as claimed in claim 2, characterised in that the aperture is defined by recesses in the fixed part and the displaceable part, respectively.

4. An EAS tag as claimed in claim 3, characterised in that a large recess is defined adjacent the recess in at least one of said parts, said large recess being configured to be brought into register with one of the recesses when the detent is resiliently deformed.

5. An EAS tag as claimed in claim 4, characterised in that the detent is a unitary component of a resilient material.

6. An EAS tag as claimed in claim 5, characterised in that the detent includes at least one resiliently deformable element extending between its fixed part and its resiliently displaceable part.

7. A method of using an EAS tag, said method including receiving a shank of a tack in an aperture defined in a detent, to hold the shank captive in the aperture, said method being characterised by releasing the shank from the detent by exerting a load from a probe onto the detent and causing part of the detent to be resiliently deformed, the deformation causing the shape of the aperture to be deformed sufficiently for the shank to be released from the detent.

8. A method of using an EAS tag as claimed in claim 7, characterised in that the deformation of the detent and its aperture is reversed by the resilience of the detent, when the load from the probe is released.

9. A method of using an EAS tag as claimed in claim 7, characterised in that part of the detent is fixedly mounted on an inside of a body of the tag and the method includes passing the probe into the tag body from its outside.

10. A method of using an EAS tag as claimed in claim 7, characterised in that the probe has a curved shape and moves arcuately inside the tag body.

11. A method of using an EAS tag as claimed in claim 7, characterised in that the probe is pressed against the detent at a point remote from the fixed attachment of the detent.

12. An EAS tag which includes a body in which a lock mechanism is housed for receiving a shank of a tack, for holding the shank captive and for releasing the shank when the lock mechanism is released, characterised in that said lock mechanism includes a resilient detent that is slidably mounted in the body and at least part of which is accessible with a probe from outside the body, said detent defining an elongate slot in which the shank is receivable in a locking manner and said detent being configured to slide when receiving a load from said probe, said sliding causing the shank to be released from the slot.

13. An EAS tag as claimed in claim 12, characterised in that the slot in the detent extends generally in the direction of sliding movement of the detent.

14. An EAS tag as claimed in claim 12, characterised in that the detent defines at least one resilient gripping formation on the periphery of the slot, which can grip the shank, when received inside the slot.

15. An EAS tag as claimed in claim 12, characterised in that the tag includes biasing means, configured to urge the detent against the direction in which it can be urged by the probe.

16. A method of using an EAS tag, said method including: receiving a shank of a tack in a slot defined in a detent to hold the shank captive, said method being characterised by releasing the shank from the detent by exerting a load from a probe onto the detent and causing the detent to slide, the sliding movement causing the shank to be released from the slot.

17. A method of using an EAS tag as claimed in claim 16, characterised in that the sliding movement of the detent is reversed by a biasing load exerted on the detent, when the load from the probe is released.

18. A method of using an EAS tag as claimed in claim 16, characterised in that the detent is fixedly mounted on an inside of a body of the tag and the method includes passing the probe into the tag body from its outside.

19. A method of using an EAS tag as claimed in claim 16, characterised in that the probe has a curved shape and moves arcuately inside the tag body.

20. A method of using an EAS tag as claimed in claim 18, characterised in that the probe has a curved shape and moves arcuately inside the tag body.
